(19) United States
(12) Patent Application Publication
(10) Pub. No.: US 2022/0255698 A1
(43) Pub. Date: Aug. 11, 2022

(54) COMMUNICATION SYSTEM AND METHOD, MOVABLE PLATFORM, AND TERMINAL DEVICE

(71) Applicant: SZ DJI TECHNOLOGY CO., LTD., Shenzhen (CN)

(72) Inventors: Yuqun CAI, Shenzhen (CN); Fushan HUANG, Shenzhen (CN); Wenyue CHEN, Shenzhen (CN)

(73) Assignee: SZ DJI TECHNOLOGY CO., LTD., Shenzhen (CN)

(21) Appl. No.: 17/685,165

(22) Filed: Mar. 2, 2022

Related U.S. Application Data
(63) Continuation of application No. PCT/CN2019/130487, filed on Dec. 31, 2019.

(51) Int. Cl. H04L 5/00

(52) U.S. Cl. CPC H04L 5/0048; H04L 5/0092; H04L 5/0053

(57) ABSTRACT

A communication system and method, a movable platform, and a terminal device are provided. The communication system includes a movable platform and a terminal device; the movable platform is configured to send a data packet, where the data packet includes attribute information of the movable platform; and the terminal device is configured to receive the data packet, and output prompt information if the attribute information in the data packet is preset attribute information, where the prompt information indicates whether to establish a communication connection between the terminal device and the movable platform.

### RELATED APPLICATIONS

The present patent document is a continuation of PCT Application Serial No. PCT/CN2019/130487, filed on Dec. 31, 2019, designating the United States and published in English, which is hereby incorporated by reference.

### TECHNICAL FIELD

The present disclosure relates to the field of communications, and in particular, to a communication system and method, a movable platform, and a terminal device.

### BACKGROUND

Short-range wireless communication is a common communication method, and short-range wireless communication technologies widely used at present include Bluetooth, wireless local area network 802.11 (WIFI), and so on. For a short-range wireless communication system, a terminal device needs to establish a connection with a movable platform before communicating with the movable platform.

In the current short-range wireless communication system, the process of establishing a connection between a terminal device and a movable platform requires a user to manually operate the terminal device, and the user needs to perform multiple operations in order to complete the connection. The whole process is complex and tedious. At the same time, it takes a long time to establish the connection with the device because the whole connection process requires multiple operations. Therefore, the connection process of the current short-range wireless communication is not user-friendly and affects user experience.

### BRIEF SUMMARY

According to an aspect of the present disclosure, a communication system is provided, including: a movable platform configured to send a data packet including attribute information of the movable platform; and a terminal device configured to receive the data packet and output prompt information upon determining that the attribute information is preset attribute information, where the prompt information indicates whether to establish a communication connection between the terminal device and the movable platform.

According to another aspect of the present disclosure, a communication method is provided, including: receiving, by a terminal device of a communication system, a data packet sent from a movable platform of the communication system, where the data packet includes attribute information of the movable platform; determining, by the terminal device, that the attribute information is preset attribute information; and outputting, by the terminal device, the data packet, prompt information to indicate whether to establish a communication connection between the terminal device and the movable platform.

### BRIEF DESCRIPTION OF THE DRAWINGS

In order to clearly describe the technical solutions in the embodiments of the present disclosure, the accompanying drawings required to describe the embodiments are briefly described below. Apparently, the accompanying drawings described below are only some exemplary embodiments of the present disclosure. Those of ordinary skill in the art may further obtain other drawings based on these accompanying drawings without creative efforts.

FIG. 1 is a schematic diagram of a communication system according to some exemplary embodiments of the present disclosure;

FIG. 2 is a schematic diagram of sending a data packet according to some exemplary embodiments of the present disclosure;

FIG. 3 shows a format of a broadcast data packet according to some exemplary embodiments of the present disclosure;

FIG. 4 shows visual prompt information displayed in the form of a pop-up window according to some exemplary embodiments of the present disclosure;

FIG. 5 is a schematic diagram of sending a connection request according to some exemplary embodiments of the present disclosure;

FIG. 6 shows visual prompt information displayed in the form of a pop-up window according to some exemplary embodiments of the present disclosure;

FIG. 7 is a flowchart of a communication method applicable to a communication system according to some exemplary embodiments of the present disclosure;

FIG. 8 is a schematic diagram of a movable platform according to some exemplary embodiments of the present disclosure;

FIG. 9 is a flowchart of a communication method applicable to a movable platform according to some exemplary embodiments of the present disclosure;

FIG. 10 is a schematic diagram of a terminal device according to some exemplary embodiments of the present disclosure; and

FIG. 11 is a flowchart diagram of a communication method applicable to a terminal device according to some exemplary embodiments of the present disclosure.

### DETAILED DESCRIPTION

Bluetooth and WIFI are common short-range wireless communication technologies, which are often used for short-range communication between a terminal device such as a mobile phone and a corresponding communication device. Taking a Bluetooth Low Energy (BLE) communication system as an example, a mobile phone needs to establish a connection with a BLE device before communicating with the BLE device. To establish a connection with the BLE device, a user first needs to open a setting interface of the mobile phone and turn on the Bluetooth communication function in the setting interface, such that the mobile phone can scan BLE devices nearby. Upon finding a BLE device, the mobile phone will add the BLE device to a Bluetooth device list of the mobile phone. When the Bluetooth device list shows multiple BLE devices, the user needs to find out a BLE device that needs to be connected and then connect to the BLE device by clicking on it.

Thus, the connection process of the current BLE communication system requires manual operations by the user, and it takes multiple operations to complete the connection. The whole process is complex and tedious. If the user is not familiar with the above connection process, it would be difficult for the user to complete the whole connection process. Even if in the case where the user is familiar with the connection process, since the mobile phone constantly scans BLE devices, the Bluetooth device list may be constantly updated, and it is easy for the user to click incorrectly and thus being connected to an undesired BLE device. At the same time, it takes a long time to connect to the BLE device because the whole connection process requires multiple operations. The WIFI communication system also has similar problems as the BLE communication system. In summary, the connection process of the current BLE communication system is not user-friendly due to the above reasons, which affects the user experience.

The following describes the technical solutions of the present disclosure with reference to some exemplary embodiments and the accompanying drawings. Apparently, the described exemplary embodiments are merely some rather than all of the embodiments of the present disclosure. All other embodiments obtained by persons of ordinary skill in the art based on these exemplary embodiments without creative efforts shall fall within the scope of protection of the present disclosure.

Some exemplary embodiments of the present disclosure provide a communication system. The communication system may be a short-range wireless communication system. A Bluetooth system is taken as an example for description in some exemplary embodiments. However, the communication system is not limited to the Bluetooth system, and may be, for example, WIFI, ZigBee, UWB, or other communication systems.

As shown in FIG. 1, the communication system of some exemplary embodiments may include a movable platform and a terminal device, which can establish a connection and communicate with each other via the Bluetooth protocol. The movable platform may be a handheld photographing apparatus, an unmanned aerial vehicle, an unmanned vehicle, a mobile robot, a smart bracelet, an audio player, etc. The terminal device may be a mobile phone, a tablet computer, a remote controller, or other types of communication devices.

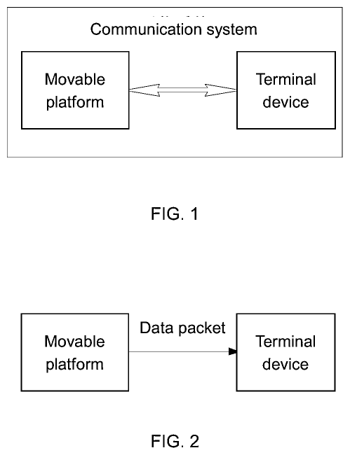

In the communication system of some exemplary embodiments, as shown in FIG. 2, the movable platform may be configured to send a data packet, where the data packet may include attribute information of the movable platform. The terminal device may be configured to receive the data packet sent by the movable platform. If the attribute information in the data packet is preset attribute information, the terminal device outputs prompt information, where the prompt information indicates whether to establish a communication connection between the terminal device and the movable platform.

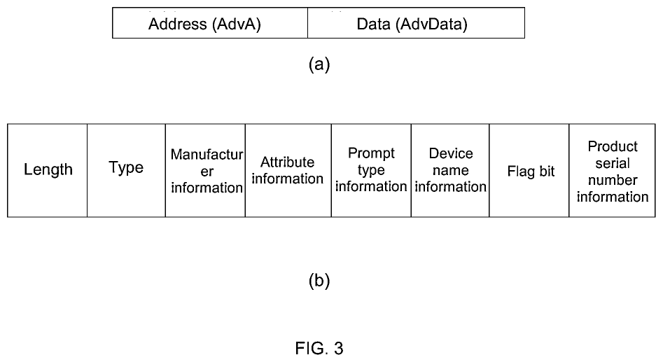

The movable platform may continuously broadcast data packets on a regular basis. In an example, a selected data packet type is Adv_ind, i.e., the movable platform broadcasts Adv_ind data packets, where each Adv_ind data packet includes attribute information. As shown in FIG. 3(a), the Adv_ind data packet may include two parts: address (AdvA) and data (AdvData). AdvA occupies 6 bytes and AdvData occupies 31 bytes. As shown in FIG. 3(b), AdvData may include multiple elements, and each element includes three parts: length, type, and data; the data part may include the attribute information.

After receiving the Adv_ind data packet broadcast by the movable platform, the terminal device may parse the Adv_ind data packet and extract the attribute information from the Adv_ind data packet. If the extracted attribute information is the preset attribute information, it indicates that the movable platform supports the terminal device to generate a prompt for the movable platform. On the contrary, if the extracted attribute information is not the preset attribute information, it indicates that the movable platform does not support the terminal device to generate a prompt for the movable platform. For ease of description, in some exemplary embodiments, the method that the terminal device generates a prompt for the movable platform by outputting the prompt information is referred to as a “discovery service”. The above description shows that the attribute information in the Adv_ind data packet actually indicates whether the movable platform supports the “discovery service”. In an example, the attribute information field may occupy 2 bytes. In an example, the preset attribute information may be 0xEFA5. If the attribute information extracted by the terminal device from the Adv_ind data packet is 0xEFA5, it indicates that the movable platform that sends the Adv_ind data packet supports the “discovery service”. In this case, the terminal device outputs prompt information, where the prompt information prompts the user to decide whether to establish a communication connection between the terminal device and the movable platform. If the attribute information extracted by the terminal device from the Adv_ind data packet is not 0xEFA5, it indicates that the mobile platform that sends the Adv_ind data packet does not support the “discovery service”. In this case, the terminal device will not output prompt information for the movable platform, and the user will not receive a prompt for the movable platform. Of course, the above is just an example, and the value of the preset attribute information may be a value other than 0xEFA5. In addition, when the functionality of the movable platform needs to be extended, at least one piece of other preset attribute information may be further set to indicate whether the movable platform supports other functions or services.

In some exemplary embodiments, the Adv_ind data packet may further include a flag bit, which may be used as an extended field reserved for other functions or services.

In some exemplary embodiments, the Adv_ind data packet may further include identity information of the movable platform. The identity information of the movable platform may include the following fields: manufacturer information, device name information, and product serial number information of the movable platform. In an example, the device name information and the product serial number information each may occupy 2 fields.

When the attribute information in the Adv_ind data packet broadcast by the movable platform is the preset attribute information and the Adv_ind data packet includes the following two fields: the device name information and the product serial number information, after receiving the Adv_ind data packet, the terminal device extracts the device name information, the product serial number information and the manufacturer information from the Adv_ind data packet, and outputs the manufacturer information, the device name information and the product serial number in the prompt information, so as to present the manufacturer information, the device name information and the product serial number to the user.

In some exemplary embodiments, the Adv_ind data packet may further include prompt type information, which is used to indicate a form of the prompt information to be outputted by the terminal device. The terminal device in some exemplary embodiments may output the prompt information in multiple forms according to the prompt type information. The prompt information may be in the form of one or more of, for example, a visual prompt, a voice prompt, and a vibration prompt.

For the movable platform, the prompt type information may include multiple pieces of prompt type information, such as first prompt type information, second prompt type information, and third prompt type information. The first prompt type information and the second prompt type information may represent different visual prompt forms. In an example, if the prompt type information is the first prompt type information, the movable platform may be displayed in a picture form on a display interface of the terminal device when the terminal device outputs the prompt information. If the prompt type information is the second prompt type information, the movable platform may be displayed in an animation form on the display interface of the terminal device when the terminal device outputs the prompt information. If the prompt type information is the third prompt type information, the terminal device may output the prompt information in a voice form.

After receiving the Adv_ind data packet broadcast by the movable platform, the terminal device may extract the prompt type information from the Adv_ind data packet, and output the prompt information according to the prompt type information. For example, a prompt for the movable platform is provided in the form of visual prompt information. In an example, when the terminal device outputs visual prompt information, the visual prompt information is displayed on the display interface of the terminal device in the form of a pop-up window. In other examples, the terminal device may also output the visual prompt information in other forms such as flashing indicator.

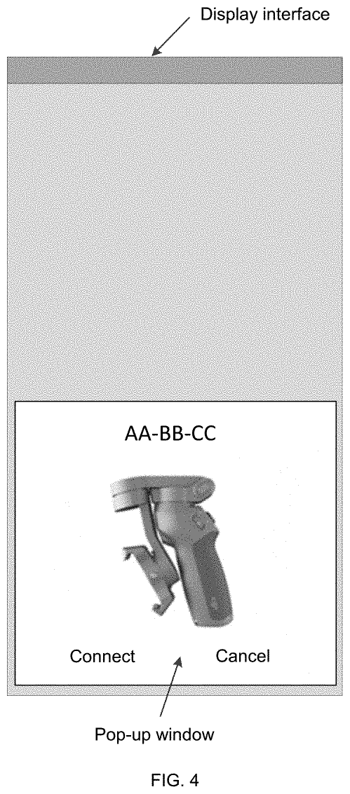

Specifically, if the prompt type information extracted by the terminal device is the first prompt type information, the terminal device may display a picture of the movable platform in the form of a pop-up window on the display interface, as shown in FIG. 4. The movable platform shown in FIG. 4 is a handheld gimbal. The terminal device may further extract the device name information, the product serial number information, and the manufacturer information from the Adv_ind data packet broadcast by the movable platform. In addition to the picture of the handheld gimbal, the manufacturer information (such as AA in FIG. 4), device name information (such as BB in FIG. 4) and product serial number information (such as CC in FIG. 4) of the handheld gimbal can also be displayed in the pop-up window at the same time. In this way, through prompt in the form of the pop-up window, the user can intuitively learn the product appearance, manufacturer information, device name information, and product serial number information of the movable platform. Similarly, if the prompt type information extracted by the terminal device is the second prompt type information, the terminal device may display an animation of the movable platform in the form of a pop-up window on the display interface. Likewise, the animation prompt in the pop-up window can also display the manufacturer information, device name information, and product serial number information of the movable platform at the same time.

The picture and animation of the movable platform may be provided by the manufacturer of the movable platform and stored in the terminal device. The terminal device may download the picture and animation of the movable platform from the manufacturer, and the picture and animation are stored in association with the device name information of the movable platform. The terminal device may find the corresponding picture and animation through the device name information in the Adv_ind data packet.

The above is merely exemplary description. In addition to the picture and animation, a visual prompt in any other type may also be used. In addition, in FIG. 4, the prompt in the form of the pop-up window displays the manufacturer information, device name information and product serial number information of the movable platform at the same time. However, a person skilled in the art can understand that, the prompt in the form of the pop-up window may alternatively include any one or two of the three types of information described above.

The visual prompt information may further include a connect icon and a cancel icon. When the terminal device obtains an operation of the user on the connect icon, the terminal device may establish a communication connection with the movable platform. When the terminal device obtains an operation of the user on the cancel icon, the terminal device does not establish a communication connection with the movable platform, and when the terminal device receives a data packet again from the movable platform to which the connection has been canceled, the terminal device does not output the prompt information. It should be noted that, that the terminal device does not output the prompt information may refer to that the terminal device does not output the prompt information within a preset period of time. The preset period of time may be, for example, one day. The user may also specify the preset period of time. For example, the prompt information may no longer be outputted permanently.

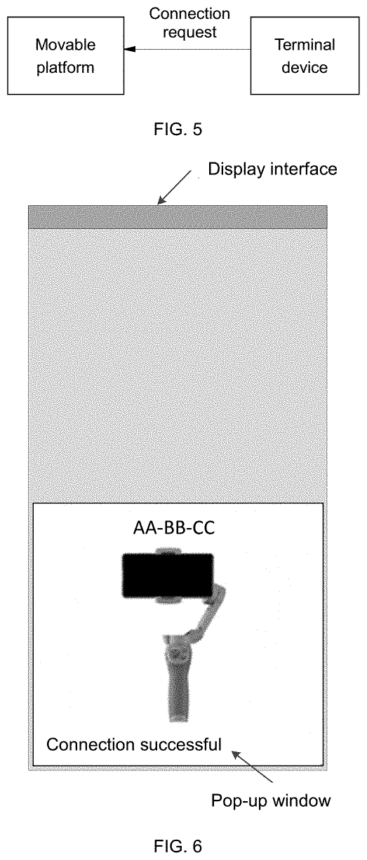

As shown in FIG. 4, the prompt in the form of the pop-up window displays two icons: “connect” and “cancel”. When the user wants to connect to the movable platform displayed in the pop-up window, the user may click on the “connect” icon. In response to the click on the “connect” icon, as shown in FIG. 5, the terminal device may send a connection request to the movable platform. After receiving the connection request, the movable platform establishes a connection with the terminal device. As shown in FIG. 6, the terminal device displays “connection successful” in the prompt in the form of the pop-up window. After that, the terminal device and the movable platform can communicate with each other, and the prompt in the form of the pop-up window is no longer displayed.

When the user does not want to establish a connection with the movable platform permanently or temporarily, the user may click on the “cancel” icon. In response to the click on the “cancel” icon, the terminal device does not send a connection request to the movable platform, and the terminal device does not establish a connection with the movable platform. The terminal device will block the movable platform temporarily. During the period of temporary blocking, even if the terminal device receives again a data packet broadcast by the movable platform, the terminal device does not generate a prompt in the form of a pop-up window for the movable platform. The period of temporary blocking may be set according to actual requirements. This can avoid frequently prompting the user when the user does not want to establish a connection with the movable platform permanently or temporarily, thus improving the user experience.

The terminal device may further provide a voice prompt of the movable platform. In an example, when the prompt type information extracted by the terminal device is the third prompt type information, the terminal device outputs the voice prompt information. The voice prompt information may broadcast: the manufacturer information, the device name information, and the product serial number information of the movable platform, or any one or two of the three types of information above.

The terminal device in some exemplary embodiments may have an audio input component. The terminal device may obtain a sound signal through the audio input component, and when the sound signal includes a preset voice signal, the terminal device establishes a communication connection with the movable platform.

For example, when the terminal device is a mobile phone, the audio input component of the mobile phone may be a microphone. When the user learns the movable platform through the voice prompt information sent by the mobile phone and wants to establish a connection with the movable platform, the user may send a sound signal. When the sound signal includes the preset voice signal, such as “connect”, the terminal device may send a connection request to the movable platform. After receiving the connection request, the movable platform establishes a connection with the terminal device. Then, the terminal device and the movable platform can communicate with each other. When the user does not want to establish a connection with the movable platform permanently or temporarily, the user may send a sound signal, such as “not connect”. The terminal device does not send a connection request to the movable platform, and the terminal device does not establish a connection with the movable platform. The terminal device will block the movable platform temporarily. During the period of temporary blocking, even if the terminal device receives again a data packet broadcast by the movable platform, the terminal device does not generate a voice prompt for the movable platform.

The terminal device may further generate a vibration prompt for the movable platform. In an example, when the prompt type information extracted by the terminal device is fourth prompt type information, the terminal device vibrates. Further, the terminal device may determine its own position and/or attitude, and determine whether to establish a communication connection with the movable platform. In an example, if the user shakes the terminal device, the terminal device may send a connection request to the movable platform. After receiving the connection request, the movable platform establishes a connection with the terminal device. Then, the terminal device and the movable platform can communicate with each other. When the user does not want to establish a connection with the movable platform, the user does not shake the terminal device. The terminal device does not send a connection request to the movable platform, and the terminal device does not establish a connection with the movable platform. The terminal device will block the movable platform temporarily. During the period of temporary blocking, even if the terminal device receives again a data packet broadcast by the movable platform, the terminal device does not generate a vibration prompt for the movable platform.

In the communication system of some exemplary embodiments, the terminal device does not output the prompt information in all states or all working modes, but only outputs the prompt information in a preset working mode. This is because in some working modes, the user may need to focus on other operations on the terminal device, and does not want to be disturbed. In consideration of such a case, to output the prompt information only in the preset working mode helps improve the user experience. For example, for the terminal device such as a mobile phone, the preset working mode includes a non-video playing mode and a non-game mode. That is, the mobile phone outputs the prompt information only when in the non-video playing mode and the non-game mode. If the mobile phone is in the non-preset working mode, for example, a video playing mode, it indicates that the user is focusing on the video being played. For another example, if the mobile phone is in a game mode, it indicates that the user is currently focusing on the game. Therefore, in the video playing mode or the game mode, the mobile phone will not output any type of prompt information, including visual prompt, voice prompt, vibration prompt, or the like, to avoid disturbing the user and improve the user experience. When the terminal device is in the non-preset working mode, the terminal device may stop scanning movable platforms nearby, and thus no longer receives data packets broadcast by any movable platform; alternatively, the terminal device may keep scanning movable platforms nearby, but even if a data packet broadcast by a movable platform is received, the terminal device will not output any type of prompt information.

In the communication system of some exemplary embodiments, the terminal device may further obtain a distance between the movable platform and the terminal device, and the terminal device may output the prompt information only when the distance is less than a predetermined distance threshold.

In many application scenarios, the user usually is only concerned with the presence of movable platforms nearby, and only wants to connect to and communicate with a movable platform nearby. The user does not want to connect to or communicate with a movable platform far away from the user. Considering the foregoing factors, the terminal device in some exemplary embodiments may first filters movable platforms according to its distances to the movable platforms to filter out each movable platform whose distance from the terminal device exceeds the predetermined distance threshold, and does not output prompt information to the movable platform whose distance from the terminal device exceeds the predetermined distance threshold.

Specifically, the terminal device outputs the prompt information only when the terminal device receives the Adv_ind data packet broadcast by the movable platform, the attribute information extracted from the Adv_ind data packet is the preset attribute information, and it is detected that the distance between the movable platform and the terminal device is less than the predetermined distance threshold; if the distance is greater than or equal to the predetermined distance threshold, even if the attribute information extracted from the Adv_ind data packet is the preset attribute information, the terminal device does not output the prompt information.

There are many methods for detecting the distance between the movable platform and the terminal device. In an example, received signal intensity indication (RSSI) of the received Adv_ind data packet may be obtained, and the distance between the terminal device and the movable platform is determined according to the RSSI. A specific value of the predetermined distance threshold is not limited in the present disclosure, and may be determined according to an actual application scenario. In an example, the predetermined distance threshold may be 30 cm. By filtering the movable platforms according to the distances between the terminal device and the movable platforms, it can avoid generating a prompt for a movable platform away from the user to disturb the user, and at the same time, it also avoids a connection to a movable platform which is beyond the predetermined distance threshold and to which the user does not want to connect, thus improving the user experience.

It can be learned that, in the communication system of some exemplary embodiments, the terminal device generates a prompt for the movable platform according to the attribute information in the data packet sent by the movable platform, and the user may implement the connection between the terminal device and the movable platform according to the prompt information. During the whole connection process, the only manual operation required is a click on the connect icon, and the rest of the process does not require manual operations by the user. Compared with the existing technologies, the connection process of the communication system in the present disclosure is simple and convenient, and the user does not need to perform tedious manual operations, and may avoid connecting to undesired movable platforms due to wrong clicks. At the same time, the whole connection process is short, and the terminal device can find the movable platform and connect to the movable platform in a short time. The implementation of the present disclosure is simple. It only needs to add certain fields in the broadcast data packet without complex modifications to the movable platform and the terminal device.

It should be noted that, the Bluetooth system is taken as an example for the description of some exemplary embodiments. However, the communication system is not limited to the Bluetooth system, and may be, for example, WIFI, ZigBee, UWB, or other various communication systems. The other short-range wireless communication systems may also include a movable platform and a terminal device, and a working process of the movable platform and the terminal device is similar to that of the Bluetooth system described above. For example, in a WIFI communication system, the movable platform broadcasts a beacon data packet.

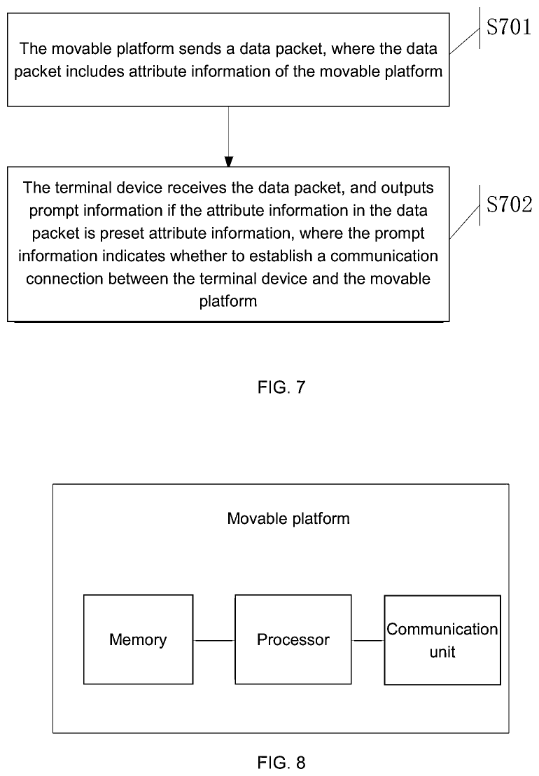

Some exemplary embodiments of the present disclosure provide a communication method, which may be applied to a communication system. The communication system includes a movable platform and a terminal device; as shown in FIG. 7, the communication method includes the following steps:

S701: The movable platform sends a data packet, where the data packet includes attribute information of the movable platform.

S702: The terminal device receives the data packet, and outputs prompt information if the attribute information in the data packet is preset attribute information, where the prompt information indicates whether to establish a communication connection between the terminal device and the movable platform.

The communication system to which some exemplary embodiments is applicable may be a short-range wireless communication system. A Bluetooth system is taken as an example for description in some exemplary embodiments. However, the communication system is not limited to the Bluetooth system, and may be, for example, WIFI, ZigBee, UWB, or other various communication systems.

The communication system in some exemplary embodiments may include movable platform and a terminal device, which can establish a connection and communicate with each other via the Bluetooth protocol. The movable platform may be a handheld photographing apparatus, an unmanned aerial vehicle, an unmanned vehicle, a mobile robot, a smart bracelet, an audio player, etc. The terminal device may be a mobile phone, a tablet computer, a remote controller, or other types of communication devices.

In the communication method of some exemplary embodiments, the movable platform sends a data packet, where the data packet includes attribute information of the movable platform. The terminal device receives the data packet sent by the movable platform. If the attribute information in the data packet is preset attribute information, the terminal device outputs prompt information, where the prompt information indicates whether to establish a communication connection between the terminal device and the movable platform.

The movable platform can continuously broadcast data packets on a regular basis. In an example, a selected data packet type is Adv_ind, i.e., the movable platform broadcasts Adv_ind data packets, where each Adv_ind data packet includes attribute information. The Adv_ind data packet may include two parts: address (AdvA) and data (AdvData). AdvData may include the attribute information.

After receiving the Adv_ind data packet broadcast by the movable platform, the terminal device parses the Adv_ind data packet and extracts the attribute information from the Adv_ind data packet. If the extracted attribute information is the preset attribute information, it indicates that the movable platform supports the terminal device to generate a prompt for the movable platform. On the contrary, if the extracted attribute information is not the preset attribute information, it indicates that the movable platform does not support the terminal device to generate a prompt for the movable platform. For ease of description, in some exemplary embodiments, the method that the terminal device generates a prompt for the movable platform by outputting the prompt information is referred to as a “discovery service”. The above description shows that the attribute information in the Adv_ind data packet actually indicates whether the movable platform supports the “discovery service”. In an example, the preset attribute information may be 0xEFA5. If the attribute information extracted by the terminal device from the Adv_ind data packet is 0xEFA5, it indicates that the movable platform that sends the Adv_ind data packet supports the “discovery service”. In this case, the terminal device outputs prompt information, where the prompt information prompts the user to decide whether to establish a communication connection between the terminal device and the movable platform. If the attribute information extracted by the terminal device from the Adv_ind data packet is not 0xEFA5, it indicates that the mobile platform that sends the Adv_ind data packet does not support the “discovery service”. In this case, the terminal device will not output prompt information for the movable platform, and the user will not receive a prompt for the movable platform.

In some exemplary embodiments, the Adv_ind data packet may further include identity information of the movable platform. The identity information of the movable platform may include the following fields: manufacturer information, device name information, and product serial number information of the movable platform.

When the attribute information in the Adv_ind data packet broadcast by the movable platform is the preset attribute information and the Adv_ind data packet includes the following two fields: the device name information and the product serial number information, after receiving the Adv_ind data packet, the terminal device extracts the device name information, the product serial number information and the manufacturer information from the Adv_ind data packet, and outputs the manufacturer information, the device name information and the product serial number in the prompt information, so as to present the manufacturer information, the device name information and the product serial number to the user.

In some exemplary embodiments, the Adv_ind data packet further includes prompt type information, which is used to indicate a form of the prompt information to be outputted by the terminal device. The terminal device in some exemplary embodiments may output the prompt information in multiple forms according to the prompt type information. The prompt information may be in the form of one or more of, for example, a visual prompt, a voice prompt, and a vibration prompt.

The prompt type information may include multiple pieces of prompt type information, such as first prompt type information, second prompt type information, and third prompt type information. The first prompt type information and the second prompt type information may represent different visual prompt forms. In an example, if the prompt type information is the first prompt type information, the movable platform may be displayed in a picture form on a display interface of the terminal device when the terminal device outputs the prompt information. If the prompt type information is the second prompt type information, the movable platform may be displayed in an animation form on the display interface of the terminal device when the terminal device outputs the prompt information. If the prompt type information is the third prompt type information, the terminal device may output the prompt information in a voice form.

After receiving the Adv_ind data packet broadcast by the movable platform, the terminal device may extract the prompt type information from the Adv_ind data packet, and outputs the prompt information according to the prompt type information. For example, a prompt for the movable platform is provided in the form of visual prompt information. In an example, when the terminal device outputs visual prompt information, the visual prompt information may be displayed on the display interface of the terminal device in the form of a pop-up window. In other examples, the terminal device may also output the visual prompt information in other forms such as a flashing indicator.

Specifically, if the prompt type information extracted by the terminal device is the first prompt type information, the terminal device may play a picture of the movable platform in the form of a pop-up window on the display interface. The terminal device may further extract the device name information, the product serial number information, and the manufacturer information from the Adv_ind data packet broadcast by the movable platform. In addition to the picture of the handheld gimbal, the manufacturer information, device name information and product serial number information of the handheld gimbal can also be displayed in the pop-up window at the same time. In this way, through prompt in the form of the pop-up window, the user can intuitively learn the product appearance, manufacturer information, device name information, and product serial number information of the movable platform. Similarly, if the prompt type information extracted by the terminal device is the second prompt type information, the terminal device may display an animation of the movable platform in the form of a pop-up window on the display interface. Likewise, the animation prompt in the pop-up window can also display the manufacturer information, device name information, and product serial number information of the movable platform at the same time.

The picture and animation of the movable platform may be provided by the manufacturer of the movable platform and stored in the terminal device. The terminal device may download the picture and animation of the movable platform from the manufacturer, and the picture and animation are stored in association with the device name information of the movable platform. The terminal device may find the corresponding picture and animation through the device name information in the Adv_ind data packet.

The above is merely exemplary description. In addition to the picture and animation, a visual prompt in any other type may also be used. In addition, the prompt in the form of the pop-up window displays the manufacturer information, device name information and product serial number information of the movable platform at the same time. However, a person skilled in the art can understand that, the prompt in the form of the pop-up window may alternatively include any one or two of the three types of information described above.

The visual prompt information may further include a connect icon and a cancel icon. When the terminal device obtains an operation of the user on the connect icon, the terminal device may establish a communication connection with the movable platform. When the terminal device obtains an operation of the user on the cancel icon, the terminal device does not establish a communication connection with the movable platform, and when the terminal device receives a data packet again from the movable platform to which the connection has been canceled, the terminal device does not output the prompt information. It should be noted that, that the terminal device does not output the prompt information may refer to that the terminal device does not output the prompt information within a preset period of time. The preset period of time may be, for example, one day. The user may also specify the preset period of time. For example, the prompt information may no longer be outputted permanently.

The prompt in the form of the pop-up window may display two icons: “connect” and “cancel”. When the user wants to connect to the movable platform displayed in the pop-up window, the user may click on the “connect” icon. In response to the click on the “connect” icon, the terminal device may send a connection request to the movable platform. After receiving the connection request, the movable platform establishes a connection with the terminal device. The terminal device displays “connection successful” in the prompt in the form of the pop-up window. After that, the terminal device and the movable platform can communicate with each other, and the prompt in the form of the pop-up window is no longer displayed.

When the user does not want to establish a connection with the movable platform permanently or temporarily, the user may click on the “cancel” icon. In response to the click on the “cancel” icon, the terminal device does not send a connection request to the movable platform, and the terminal device does not establish a connection with the movable platform. The terminal device will block the movable platform temporarily. During the period of temporary blocking, even if the terminal device receives again a data packet broadcast by the movable platform, the terminal device does not generate a prompt in the form of a pop-up window for the movable platform. The period of temporary blocking may be set according to actual requirements. This can avoid frequently prompting the user when the user does not want to establish a connection with the movable platform permanently or temporarily, thus improving the user experience.

The terminal device may further provide a voice prompt of the movable platform. In an example, when the prompt type information extracted by the terminal device is the third prompt type information, the terminal device outputs the voice prompt information. The voice prompt information may broadcast: the manufacturer information, the device name information, and the product serial number information of the movable platform, or any one or two of the three types of information above.

The terminal device in some exemplary embodiments may have an audio input component. The terminal device may obtain a sound signal through the audio input component, and when the sound signal includes a preset voice signal, the terminal device establishes a communication connection with the movable platform.

For example, when the terminal device is a mobile phone, the audio input component of the mobile phone may be a microphone. When the user learns the movable platform through the voice prompt information sent by the mobile phone and wants to establish a connection with the movable platform, the user may send a sound signal. When the sound signal includes the preset voice signal, such as “connect”, the terminal device may send a connection request to the movable platform. After receiving the connection request, the movable platform establishes a connection with the terminal device. Then, the terminal device and the movable platform can communicate with each other. When the user does not want to establish a connection with the movable platform permanently or temporarily, the user may send a sound signal, such as “not connect”. The terminal device does not send a connection request to the movable platform, and the terminal device does not establish a connection with the movable platform. The terminal device will block the movable platform temporarily. During the period of temporary blocking, even if the terminal device receives again a data packet broadcast by the movable platform, the terminal device does not generate a voice prompt for the movable platform.

The terminal device may further generate a vibration prompt for the movable platform. In an example, when the prompt type information extracted by the terminal device is fourth prompt type information, the terminal device vibrates. Further, the terminal device may determine its own position and/or attitude, and determine whether to establish a communication connection with the movable platform. In an example, if the user shakes the terminal device, the terminal device may send a connection request to the movable platform. After receiving the connection request, the movable platform establishes a connection with the terminal device. Then, the terminal device and the movable platform can communicate with each other. When the user does not want to establish a connection with the movable platform, the user does not shake the terminal device. The terminal device does not send a connection request to the movable platform, and the terminal device does not establish a connection with the movable platform. The terminal device will block the movable platform temporarily. During the period of temporary blocking, even if the terminal device receives again a data packet broadcast by the movable platform, the terminal device does not generate a vibration prompt for the movable platform.

In the communication system of some exemplary embodiments, the terminal device does not output the prompt information in all states or all working modes, but only outputs the prompt information in a preset working mode. For example, for the terminal device such as a mobile phone, the preset working mode includes a non-video playing mode and a non-game mode. That is, the mobile phone outputs the prompt information only when in the non-video playing mode and the non-game mode. If the mobile phone is in the non-preset working mode, for example, a video playing mode, it indicates that the user is focusing on the video being played. For another example, if the mobile phone is in a game mode, it indicates that the user is currently focusing on the game. Therefore, in the video playing mode or the game mode, the mobile phone will not output any type of prompt information, to avoid disturbing the user and improve the user experience. When the terminal device is in the non-preset working mode, the terminal device may stop scanning movable platforms nearby, and thus no longer receives data packets broadcast by any movable platform; alternatively, the terminal device may keep scanning movable platforms nearby, but even if a data packet broadcast by a movable platform is received, the terminal device will not output any type of prompt information.

In the communication system of some exemplary embodiments, the terminal device may further obtain a distance between the movable platform and the terminal device, and the terminal device may output the prompt information only when the distance is less than a predetermined distance threshold.

In many application scenarios, the user usually is only concerned with the presence of movable platforms nearby, and only wants to connect to and communicate with a movable platform nearby. The user does not want to connect to or communicate with a movable platform far away from the user. Considering the foregoing factors, the terminal device in some exemplary embodiments first filters movable platforms according to its distances to the movable platforms to filter out each movable platform whose distance from the terminal device exceeds the predetermined distance threshold, and does not output prompt information to the movable platform whose distance from the terminal device exceeds the predetermined distance threshold.

Specifically, the terminal device outputs the prompt information only when the terminal device receives the Adv_ind data packet broadcast by the movable platform, the attribute information extracted from the Adv_ind data packet is the preset attribute information, and it is detected that the distance between the movable platform and the terminal device is less than the predetermined distance threshold; if the distance is greater than or equal to the predetermined distance threshold, even if the attribute information extracted from the Adv_ind data packet is the preset attribute information, the terminal device does not output the prompt information.

There are many methods for detecting the distance between the movable platform and the terminal device. In an example, received signal intensity indication (RSSI) of the received Adv_ind data packet may be obtained, and the distance between the terminal device and the movable platform is determined according to the RSSI. A specific value of the predetermined distance threshold is not limited in some exemplary embodiments, and may be determined according to an actual application scenario. In an example, the predetermined distance threshold may be 30 cm. By filtering the movable platforms according to the distances between the terminal device and the movable platforms, it can avoid generating a prompt for a movable platform away from the user to disturb the user, and at the same time, it also avoids a connection to a movable platform which is beyond the predetermined distance threshold and to which the user does not want to connect, thus improving the user experience.

It can be learned that, in the communication method of some exemplary embodiments, the terminal device generates a prompt for the movable platform according to the attribute information in the data packet sent by the movable platform, and the user may implement the connection between the terminal device and the movable platform according to the prompt information. During the whole connection process, the only manual operation required is a click on the connect icon, and the rest of the process does not require manual operations by the user. Compared with the existing technologies, the connection process of the communication system in some exemplary embodiments is simple and convenient, and the user does not need to perform tedious manual operations, and can avoid connecting to undesired movable platforms due to wrong clicks. At the same time, the whole connection process is short, and the terminal device can find the movable platform and connect to the movable platform in a short time. The implementation of some exemplary embodiments is simple. It only needs to add certain fields in the broadcast data packet, without complex modifications to the movable platform and the terminal device.

It should be noted that, the Bluetooth system is taken as an example for the description of some exemplary embodiments. However, the communication method is not limited to being applied to the Bluetooth system, and may be applied to, for example, WIFI, ZigBee, UWB, or other various communication systems. The other short-range wireless communication systems may also include a movable platform and a terminal device, and a working process of the movable platform and the terminal device is similar to that of the Bluetooth system described above. For example, in a WIFI communication system, the movable platform broadcasts a beacon data packet.

Further, some exemplary embodiments of the present disclosure provide a movable platform. The movable platform may be a communication device in a short-range wireless communication system. A Bluetooth system is taken as an example for description. However, the communication system is not limited to the Bluetooth system, and may be, for example, WIFI, ZigBee, UWB, or other various communication systems. The movable platform may be a handheld photographing apparatus, an unmanned aerial vehicle, an unmanned vehicle, a mobile robot, a smart bracelet, an audio player, etc.

As shown in FIG. 8, the movable platform in some exemplary embodiments includes:

at least one memory (which is an example of a storage medium), configured to store executable instructions;

at least one processor, configured to execute the executable instructions stored in the memory, to perform the following operation:

send a data packet, where the data packet includes attribute information of the movable platform; and

a communication unit, configured to send the data packet, where the data packet may be received by a terminal device, the terminal device may output prompt information if the attribute information in the data packet is preset attribute information, and the prompt information indicates whether to establish a communication connection between the terminal device and the movable platform.

In an example, a selected data packet type is Adv_ind, i.e., the movable platform broadcasts Adv_ind data packets. The Adv_ind data packet may include two parts: address (AdvA) and data (AdvData), and the Adv_ind data packet may include the attribute information.

When the attribute information is the preset attribute information, it indicates that the movable platform supports the terminal device to generate a prompt for the movable platform. On the contrary, if the attribute information is not the preset attribute information, it indicates that the movable platform does not support the terminal device to generate a prompt for the movable platform. For ease of description, in some exemplary embodiments, the method that the terminal device generates a prompt for the movable platform by outputting the prompt information is referred to as a “discovery service”. The above description shows that the attribute information in the Adv_ind data packet actually indicates whether the movable platform supports the “discovery service”. In an example, the attribute information field may occupy 2 bytes. In an example, the preset attribute information may be 0xEFA5. If the attribute information in the Adv_ind data packet is 0xEFA5, it indicates that the movable platform that sends the Adv_ind data packet supports the “discovery service”. In this case, the terminal device outputs prompt information, where the prompt information prompts the user to decide whether to establish a communication connection between the terminal device and the movable platform. If the attribute information in the Adv_ind data packet is not 0xEFA5, it indicates that the mobile platform that sends the Adv_ind data packet does not support the “discovery service”. In this case, the terminal device will not output prompt information for the movable platform, and the user will not receive a prompt for the movable platform. Of course, the above is just an example, and the value of the preset attribute information may be a value other than 0xEFA5. In addition, when the functionality of the movable platform needs to be extended, at least one piece of other preset attribute information can further be set to indicate whether the movable platform supports other functions or services.

In some exemplary embodiments, the Adv_ind data packet may further include a flag bit, which may be used as an extended field reserved for other functions or services.

In some exemplary embodiments, the Adv_ind data packet may further include identity information of the movable platform. The identity information of the movable platform may include the following fields: manufacturer information, device name information, and product serial number information of the movable platform.

When the attribute information in the Adv_ind data packet broadcast by the movable platform is the preset attribute information and the Adv_ind data packet includes the following two fields: the device name information and the product serial number information, the terminal device extracts the device name information, the product serial number information and the manufacturer information from the Adv_ind data packet, and outputs the manufacturer information, the device name information and the product serial number in the prompt information, so as to present the manufacturer information, the device name information and the product serial number to the user.

In some exemplary embodiments, the Adv_ind data packet may further include prompt type information, which is used to indicate a form of the prompt information. The terminal device may output the prompt information according to the prompt type information. The prompt information may be in the form of one or more of, for example, a visual prompt, a voice prompt, and a vibration prompt.

For the movable platform, the prompt type information may include multiple pieces of prompt type information, such as first prompt type information, second prompt type information, and third prompt type information. The first prompt type information and the second prompt type information may represent different visual prompt forms. In an example, if the prompt type information is the first prompt type information, the movable platform may be displayed in a picture form on a display interface of the terminal device when the terminal device outputs the prompt information. If the prompt type information is the second prompt type information, the movable platform may be displayed in an animation form on the display interface of the terminal device when the terminal device outputs the prompt information. If the prompt type information is the third prompt type information, the terminal device may output the prompt information in a voice form.

In an example, when the terminal device outputs visual prompt information, the visual prompt information is displayed on the display interface of the terminal device in the form of a pop-up window. In other examples, the terminal device may also output the visual prompt information in other forms such as a flashing indicator.

Specifically, if the prompt type information is the first prompt type information, the terminal device may display a picture of the movable platform in the form of a pop-up window on the display interface. In addition to the picture of the movable platform, the manufacturer information, device name information, and product serial number information of the movable platform can also be displayed in the pop-up window at the same time. In this way, through prompt in the form of the pop-up window, the user can intuitively learn the product appearance, manufacturer information, device name information, and product serial number information of the movable platform. Similarly, if the prompt type information is the second prompt type information, the terminal device may display an animation of the movable platform in the form of a pop-up window on the display interface. Likewise, the animation prompt in the pop-up window can also display the manufacturer information, device name information, and product serial number information of the movable platform at the same time.

The visual prompt information of the terminal device may further include a connect icon and a cancel icon. When the terminal device obtains an operation of the user on the connect icon, the movable platform may establish a communication connection with the terminal device. When the terminal device obtains an operation of the user on the cancel icon, the movable platform does not establish a communication connection with the terminal device, and when a data packet from the movable platform is received by the terminal device again, the terminal device does not output the prompt information. This can avoid frequently prompting the user when the user does not want to establish a connection with the movable platform permanently or temporarily, thus improving the user experience.

In an example, when the prompt type information is the third prompt type information, the terminal device can output the voice prompt information. The voice prompt information may broadcast: the manufacturer information, the device name information, and the product serial number information of the movable platform, or any one or two of the three types of information above.

When the user knows the movable platform through the voice prompt information sent by the mobile phone and wants to establish a connection with the movable platform, the user may send a sound signal. When the sound signal includes the preset voice signal, such as “connect”, the mobile terminal receives a connection request sent by the terminal device. After receiving the connection request, the movable platform establishes a connection with the terminal device. Then, the terminal device and the movable platform can communicate with each other. When the user does not want to establish a connection with the movable platform permanently or temporarily, the user may send a sound signal, such as “not connect”. The movable platform does not receive a connection request from the terminal device, and does not establish a connection with the terminal device. The terminal device will block the movable platform temporarily. During the period of temporary blocking, even if the terminal device receives again a data packet broadcast by the movable platform, the terminal device does not generate a voice prompt for the movable platform.

The terminal device may further generate a vibration prompt for the movable platform. In an example, when the prompt type information extracted by the terminal device is fourth prompt type information, the terminal device vibrates. Further, the terminal device may determine its own position and/or attitude, and determine whether to establish a communication connection with the movable platform. In an example, if the user shakes the terminal device, the terminal device may send a connection request to the movable platform. After receiving the connection request, the movable platform establishes with the terminal device. Then, the terminal device and the movable platform can communicate with each other. When the user does not want to establish a connection with the movable platform, the user does not shake the terminal device. The terminal device does not send a connection request to the movable platform, and the terminal device does not establish a connection with the movable platform. The terminal device will block the movable platform temporarily. During the period of temporary blocking, even if the terminal device receives again a data packet broadcast by the movable platform, the terminal device does not generate a vibration prompt for the movable platform.

It can be learned that, the data packet sent by the movable platform of some exemplary embodiments includes the attribute information, where the attribute information may be used for instructing the terminal device to generate a prompt for the movable platform. The user may implement the connection between the terminal device and the movable platform according to the prompt information. During the whole connection process, the only manual operation required is a click on the connect icon, and the rest of the process does not require manual operations by the user. Compared with the existing technologies, the connection process of the mobile platform and the terminal device is simple and convenient, and the user does not need to perform tedious manual operations, and can avoid connecting to undesired movable platforms due to wrong clicks. At the same time, the whole connection process is short, and the terminal device can find the movable platform and connect to the movable platform in a short time. The implementation of the present disclosure is simple. It only needs to add certain fields in the broadcast data packet, without complex modifications to the movable platform and the terminal device.

It should be noted that, the Bluetooth system is taken as an example for the description of some exemplary embodiments. However, the movable platform of the present disclosure is not limited to the communication device in the Bluetooth system, and may be a communication device in, for example, WIFI, ZigBee, UWB, or other various communication systems. The working process of the movable platform in the other short-range wireless communication systems is similar to that of movable platform in the Bluetooth system described above. For example, in a WIFI communication system, the movable platform broadcasts a beacon data packet.

Further, some exemplary embodiments of the present disclosure provide a communication method. The communication method is applicable to a movable platform, and the movable platform may be a communication device in a short-range wireless communication system. A Bluetooth system is taken as an example for description herein. However, the communication system is not limited to the Bluetooth system, and may be, for example, WIFI, ZigBee, UWB, or other communication systems. The movable platform may be used as a peripheral device or slave device of the Bluetooth system, and may be a handheld photographing apparatus, an unmanned aerial vehicle, an unmanned vehicle, a mobile robot, a smart bracelet, an audio player, etc.

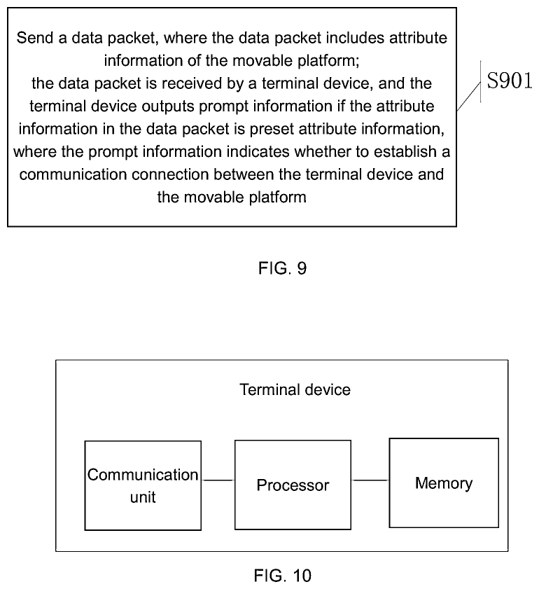

As shown in FIG. 9, the communication method of some exemplary embodiments may include the following steps:

S901: Send a data packet, where the data packet includes attribute information of the movable platform.

The data packet may be received by a terminal device, and the terminal device may output prompt information if the attribute information in the data packet is preset attribute information, where the prompt information indicates whether to establish a communication connection between the terminal device and the movable platform.

The data packet may further include identity information of the movable platform. The identity information includes one or more of manufacturer information, device name information, and product serial number information of the movable platform, such that the terminal device of the short-range wireless communication system outputs one or more of the manufacturer information, device name information, and product serial number information of the movable platform when outputting the prompt information.

The data packet may further include prompt type information, which is used to indicate a form of the prompt information. The prompt type information includes: first prompt type information, second prompt type information and third prompt type information.

The first prompt type information may be used for instructing the terminal device to display the movable platform in a picture form; the second prompt type information may be used for instructing the terminal device to display the movable platform in an animation form; the third prompt type information may be used for instructing the terminal device to display the prompt information in a voice form.

The prompt information may be visual prompt information, and the visual prompt information may include a connect icon and a cancel icon. In response to that the terminal device obtains an operation of the user on the connect icon, a communication connection with the movable platform is established. In response to that the terminal device obtains an operation of the user on the cancel icon, a communication connection with the movable platform is not established.

The prompt information may be voice prompt information; in response to that the sound signal obtained by the terminal device includes a preset voice signal, a communication connection with the terminal device is established.

Further, some exemplary embodiments of the present disclosure provide a computer readable storage medium, which stores executable instructions. The executable instructions, when executed by one or more processors, can cause the one or more processors to perform the communication method in the foregoing embodiment.

Some exemplary embodiments of the present disclosure provide a terminal device. The terminal device may be a communication device in a short-range wireless communication system. A Bluetooth system is taken as an example for description herein. However, the communication system is not limited to the Bluetooth system, and may be, for example, WIFI, ZigBee, UWB, or other various communication systems.

The terminal device may establish a connection and communicate with a movable platform via the Bluetooth protocol. The terminal device may be a mobile phone, a tablet computer, a remote controller, or other types of communication devices.

As shown in FIG. 10, the terminal device of some exemplary embodiments includes a communication unit, at least a memory (which is an example of a storage medium), and at least a processor.

The memory is configured to store executable instructions.

The processor is configured to execute the executable instructions stored in the memory, to perform the following operations:

receiving a data packet sent by a movable platform, where the data packet includes attribute information of the movable platform; and

if the attribute information in the data packet is preset attribute information, output prompt information, where the prompt information is used for indicating whether to establish a communication connection between the terminal device and the movable platform. The communication unit is configured to receive the data packet sent by the movable platform.

The communication unit of the terminal device receives the data packet sent by the movable platform. If the attribute information in the data packet is preset attribute information, the prompt information is outputted, where the prompt information is used for indicating whether to establish a communication connection between the terminal device and the movable platform.

In an example, the movable platform broadcasts Adv_ind data packets, where each Adv_ind data packet includes attribute information. The Adv_ind data packet may include two parts: address (AdvA) and data (AdvData). The AdvData part further may include the attribute information.

After receiving the Adv_ind data packet broadcast by the movable platform, the terminal device may parse the Adv_ind data packet and extract the attribute information from the Adv_ind data packet. If the extracted attribute information is the preset attribute information, it indicates that the movable platform supports the terminal device to generate a prompt for the movable platform. On the contrary, if the extracted attribute information is not the preset attribute information, it indicates that the movable platform does not support the terminal device to generate a prompt for the movable platform. For ease of description, in some exemplary embodiments, the method that the terminal device generates a prompt for the movable platform by outputting the prompt information is referred to as a “discovery service”. The above description shows that the attribute information in the Adv_ind data packet actually indicates whether the movable platform supports the “discovery service”. In an example, the attribute information field may occupy 2 bytes. In an example, the preset attribute information may be 0xEFA5. If the attribute information extracted by the terminal device from the Adv_ind data packet is 0xEFA5, it indicates that the movable platform that sends the Adv_ind data packet supports the “discovery service”. In this case, the terminal device outputs prompt information, where the prompt information prompts the user to decide whether to establish a communication connection between the terminal device and the movable platform. If the attribute information extracted by the terminal device from the Adv_ind data packet is not 0xEFA5, it indicates that the mobile platform that sends the Adv_ind data packet does not support the “discovery service”. In this case, the terminal device will not output prompt information for the movable platform, and the user will not receive a prompt for the movable platform. Of course, the above is just an example, and the value of the preset attribute information may be a value other than 0xEFA5. In addition, when the functionality of the movable platform needs to be extended, at least one piece of other preset attribute information may be further set to indicate whether the movable platform supports other functions or services.

In some exemplary embodiments, the Adv_ind data packet may further include a flag bit, which may be used as an extended field reserved for other functions or services.

In some exemplary embodiments, the Adv_ind data packet may further include identity information of the movable platform. The identity information of the movable platform may include the following fields: manufacturer information, device name information, and product serial number information of the movable platform. When the attribute information in the Adv_ind data packet broadcast by the movable platform is the preset attribute information and the Adv_ind data packet includes the following two fields: the device name information and the product serial number information, after receiving the Adv_ind data packet, the terminal device extracts the device name information, the product serial number information and the manufacturer information from the Adv_ind data packet, and outputs the manufacturer information, the device name information and the product serial number in the prompt information, so as to present the manufacturer information, the device name information and the product serial number to the user.

The Adv_ind data packet may further include prompt type information, which is used to indicate a form of the prompt information to be outputted by the terminal device. The terminal device in some exemplary embodiments may output the prompt information in multiple forms according to the prompt type information. The prompt information may be in the form of one or more of, for example, a visual prompt, a voice prompt, and a vibration prompt.

After receiving the Adv_ind data packet broadcast by the movable platform, the terminal device may extract the prompt type information from the Adv_ind data packet, and output the prompt information according to the prompt type information. For example, a prompt for the movable platform is provided in the form of visual prompt information.

In an example, when the terminal device outputs visual prompt information, the visual prompt information is displayed on the display interface of the terminal device in the form of a pop-up window. In other examples, the terminal device may also output the visual prompt information in other forms such as a flashing indicator.

Specifically, if the prompt type information extracted by the terminal device is the first prompt type information, the terminal device may display a picture of the movable platform in the form of a pop-up window on the display interface. The terminal device may further extract the device name information, the product serial number information, and the manufacturer information from the Adv_ind data packet broadcast by the movable platform. In addition to the picture of the movable platform, the manufacturer information, device name information and product serial number information of the movable platform can also be displayed in the pop-up window at the same time. In this way, through prompt in the form of the pop-up window, the user can intuitively learn the product appearance, manufacturer information, device name information, and product serial number information of the movable platform. Similarly, if the prompt type information extracted by the terminal device is the second prompt type information, the terminal device may display an animation of the movable platform in the form of a pop-up window on the display interface. Likewise, the animation prompt in the pop-up window can also display the manufacturer information, device name information, and product serial number information of the movable platform at the same time.

The picture and animation of the movable platform may be provided by the manufacturer of the movable platform and stored in the terminal device. The terminal device may download the picture and animation of the movable platform from the manufacturer, and the picture and animation are stored in association with the device name information of the movable platform. The terminal device may find the corresponding picture and animation through the device name information in the Adv_ind data packet.

The above is merely exemplary description. In addition to the picture and animation, a visual prompt in any other type may also be used. In addition, the prompt in the form of the pop-up window can further display the manufacturer information, device name information and product serial number information of the movable platform at the same time. However, a person skilled in the art can understand that, the prompt in the form of the pop-up window may alternatively include any one or two of the three types of information described above.

The visual prompt information may further include a connect icon and a cancel icon. When the terminal device obtains an operation of the user on the connect icon, the terminal device may establish a communication connection with the movable platform. When the terminal device obtains an operation of the user on the cancel icon, the terminal device does not establish a communication connection with the movable platform, and when the terminal device receives a data packet again from the movable platform to which the connection has been canceled, the terminal device does not output the prompt information. It should be noted that, that the terminal device does not output the prompt information may refer to that the terminal device does not output the prompt information within a preset period of time. The preset period of time may be, for example, one day. The user may also specify the preset period of time. For example, the prompt information may no longer be outputted permanently.

The terminal device may further provide a voice prompt of the movable platform. In an example, when the prompt type information extracted by the terminal device is the third prompt type information, the terminal device may output the voice prompt information. The voice prompt information may broadcast: the manufacturer information, the device name information, and the product serial number information of the movable platform, or any one or two of the three types of information above.

The terminal device in some exemplary embodiments may have an audio input component. The terminal device may obtain a sound signal through the audio input component, and when the sound signal includes a preset voice signal, the terminal device establishes a communication connection with the movable platform.

For example, when the terminal device is a mobile phone, the audio input component of the mobile phone may be a microphone. When the user learns the movable platform through the voice prompt information sent by the mobile phone and wants to establish a connection with the movable platform, the user may send a sound signal. When the sound signal includes the preset voice signal, such as “connect”, the terminal device may send a connection request to the movable platform. After receiving the connection request, the movable platform establishes a connection with the terminal device. Then, the terminal device and the movable platform can communicate with each other. When the user does not want to establish a connection with the movable platform permanently or temporarily, the user may send a sound signal, such as “not connect”. The terminal device does not send a connection request to the movable platform, and the terminal device does not establish a connection with the movable platform. The terminal device will block the movable platform temporarily. During the period of temporary blocking, even if the terminal device receives again a data packet broadcast by the movable platform, the terminal device does not generate a voice prompt for the movable platform.

The terminal device may further generate a vibration prompt for the movable platform. In an example, when the prompt type information extracted by the terminal device is fourth prompt type information, the terminal device vibrates. Further, the terminal device may determine its own position and/or attitude, and determine whether to establish a communication connection with the movable platform. In an example, if the user shakes the terminal device, the terminal device may send a connection request to the movable platform. After receiving the connection request, the movable platform establishes a connection with the terminal device. Then, the terminal device and the movable platform can communicate with each other. When the user does not want to establish a connection with the movable platform, the user does not shake the terminal device. The terminal device does not send a connection request to the movable platform, and the terminal device does not establish a connection with the movable platform. The terminal device will block the movable platform temporarily. During the period of temporary blocking, even if the terminal device receives again a data packet broadcast by the movable platform, the terminal device does not generate a vibration prompt for the movable platform.

The terminal device of some exemplary embodiments does not output the prompt information in all states or all working modes, but only outputs the prompt information in a preset working mode. This is because in some working modes, the user may need to focus on other operations on the terminal device, and does not want to be disturbed. In consideration of such a case, to output the prompt information only in the preset working mode helps improve the user experience. For example, for the terminal device such as a mobile phone, the preset working mode includes a non-video playing mode and a non-game mode. That is, the mobile phone outputs the prompt information only when in the non-video playing mode and the non-game mode. If the mobile phone is in the non-preset working mode, for example, a video playing mode, it indicates that the user is focusing on the video being played. For another example, if the mobile phone is in a game mode, it indicates that the user is currently focusing on the game. Therefore, in the video playing mode or the game mode, the mobile phone will not output any type of prompt information, including visual prompt, voice prompt, vibration prompt, or the like, to avoid disturbing the user and improve the user experience. When the terminal device is in the non-preset working mode, the terminal device may stop scanning movable platforms nearby, and thus no longer receives data packets broadcast by any movable platform; alternatively, the terminal device may keep scanning movable platforms nearby, but even if a data packet broadcast by a movable platform is received, the terminal device will not output any type of prompt information.

The terminal device of some exemplary embodiments may further obtain a distance between the movable platform and the terminal device, and the terminal device may output the prompt information only when the distance is less than a predetermined distance threshold.

In many application scenarios, the user usually is only concerned with the presence of movable platforms nearby, and only wants to connect to and communicate with a movable platform nearby. The user does not want to connect to or communicate with a movable platform far away from the user. Considering the foregoing factors, the terminal device in some exemplary embodiments may first filter movable platforms according to its distances to the movable platforms to filter out each movable platform whose distance from the terminal device exceeds the predetermined distance threshold, and does not output prompt information to the movable platform whose distance from the terminal device exceeds the predetermined distance threshold.

Specifically, the terminal device outputs the prompt information only when the terminal device receives the Adv_ind data packet broadcast by the movable platform, the attribute information extracted from the Adv_ind data packet is the preset attribute information, and it is detected that the distance between the movable platform and the terminal device is less than the predetermined distance threshold; if the distance is greater than or equal to the predetermined distance threshold, even if the attribute information extracted from the Adv_ind data packet is the preset attribute information, the terminal device does not output the prompt information.

There are many methods for detecting the distance between the movable platform and the terminal device. In an example, received signal intensity indication (RSSI) of the received Adv_ind data packet may be obtained, and the distance between the terminal device and the movable platform is determined according to the RSSI. A specific value of the predetermined distance threshold is not limited in some exemplary embodiments, and may be determined according to an actual application scenario. In an example, the predetermined distance threshold may be 30 cm. By filtering the movable platforms according to the distances between the terminal device and the movable platforms, it can avoid generating a prompt for a movable platform away from the user to disturb the user, and at the same time, it also avoids a connection to a movable platform which is beyond the predetermined distance threshold and to which the user does not want to connect, thus improving the user experience.

It can be learned that, the terminal device of some exemplary embodiments generates a prompt for the movable platform according to the attribute information in the data packet sent by the movable platform, and the user may implement the connection between the terminal device and the movable platform according to the prompt information. During the whole connection process, the only manual operation required is a click on the connect icon, and the rest of the process does not require manual operations by the user. Compared with the existing technologies, the connection process of the communication system in some exemplary embodiments is simple and convenient, and the user does not need to perform tedious manual operations, and may avoid connecting to undesired movable platforms due to wrong clicks. At the same time, the whole connection process is short, and the terminal device may find the movable platform and connect to the movable platform in a short time. The implementation of some exemplary embodiments is simple. It only needs to add certain fields in the broadcast data packet without complex modifications to the movable platform and the terminal device.

Further, some exemplary embodiments of the present disclosure provide a communication method. The communication method is applicable to a terminal device. The terminal device may be a communication device in a short-range wireless communication system. A Bluetooth system is taken as an example for description herein. However, the communication system is not limited to the Bluetooth system, and may be, for example, WIFI, ZigBee, UWB, or other various communication systems.

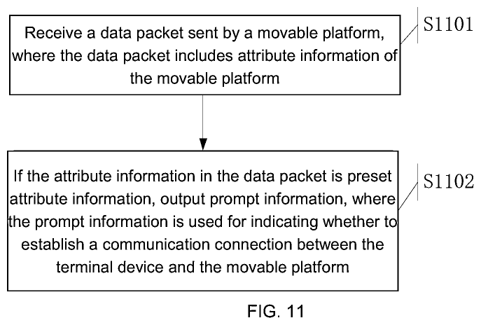

As shown in FIG. 11, the communication method of some exemplary embodiments may include the following steps:

S1101: Receive a data packet sent by a movable platform, where the data packet includes attribute information of the movable platform.

S1102: If the attribute information in the data packet is preset attribute information, output prompt information, where the prompt information is used for indicating whether to establish a communication connection between the terminal device and the movable platform.

The data packet may further include identity information of the movable platform. The identity information includes one or more of manufacturer information, device name information, and product serial number information of the movable platform; the outputting the prompt information includes: outputting one or more of the manufacturer information, device name information, and product serial number information of the movable platform.

The data packet may further include prompt type information; the outputting the prompt information may include: outputting the prompt information in a form indicated by the prompt type information. If the prompt type information is first prompt type information, the movable platform is displayed in a picture form; if the prompt type information is second prompt type information, the movable platform is displayed in an animation form. If the prompt type information is third prompt type information, the prompt information is outputted in a voice form.

The prompt information may be visual prompt information, and the outputting the prompt information may include: displaying the visual prompt information in the form of a pop-up window.

The visual prompt information may include a connect icon and a cancel icon. When an operation of the user on the connect icon is obtained, a communication connection with the movable platform is established. When an operation of the user on the cancel icon is obtained, a communication connection with the movable platform is not established, and when a data packet from the movable platform is received again, prompt information is not outputted.

The prompt information may be voice prompt information. After the operation of outputting the prompt information, the communication method may further include: obtaining a sound signal, and when the sound signal includes a preset voice signal, establishing a communication connection with the movable platform.

The outputting the prompt information may further include: outputting the prompt information in a preset working mode. The preset working mode may include a non-video playing mode and a non-game mode.

The communication method may further include the following steps:

obtaining a distance between the movable platform and the terminal device;

and outputting the prompt information only when the distance is less than a predetermined distance threshold. The distance is obtained in the following manner: obtaining signal intensity of the received data packet; and determining the distance between the terminal device and the movable platform according to the signal intensity.

Further, some exemplary embodiments of the present disclosure further provide a computer readable storage medium storing executable instructions. The executable instructions, when executed by one or more processors, can cause the one or more processors to perform the communication method in the foregoing embodiments.

Those skilled in the art understand that, for convenience and conciseness of description, the division of the foregoing function modules is only used as an example. In practical applications, the foregoing functions may be allocated to and completed by different function modules as required, that is, an internal structure of the apparatus may be divided into different function modules to perform all or some of the functions described above. For a specific working process of the apparatus described above, reference may be made to the corresponding processes in the foregoing exemplary method embodiments. Details are not described herein again.

Finally, it should be noted that the foregoing embodiments are merely intended to describe and not to limit the technical solutions of the present disclosure. Although the present disclosure has been described in detail with reference to the foregoing exemplary embodiments, persons of ordinary skill in the art should understand that they can still make modifications to the technical solutions described in the foregoing exemplary embodiments or make equivalent replacements to some or all of the technical features thereof. The features in the embodiments of the present disclosure can be combined randomly if there is no conflict. These modifications or replacements do not make the essence of the corresponding technical solutions deviate from the scope of the technical solutions of the present disclosure.

What is claimed is:

1. A communication system, comprising:
a movable platform configured to send a data packet including attribute information of the movable platform; and
a terminal device configured to receive the data packet and output prompt information upon determining that the attribute information is preset attribute information, wherein
the prompt information indicates whether to establish a communication connection between the terminal device and the movable platform.

2. The communication system according to claim 1, wherein the data packet further includes identity information of the movable platform including at least one of:
manufacturer information, device name information, or product serial number information of the movable platform.

3. The communication system according to claim 2, wherein the prompt information includes the identity information of the movable platform.

4. The communication system according to claim 1, wherein the data packet further includes prompt type information to indicate a form of the prompt information to be outputted by the terminal device.

5. The communication system according to claim 4, wherein to output the prompt information, the terminal device:
displays the movable platform in a picture form after receiving a data packet that includes first prompt type information; and
displays the movable platform in an animation form after receiving a data packet that includes second prompt type information.

6. The communication system according to claim 4, wherein the terminal device outputs the prompt information in a voice form after receiving a data packet that includes third prompt type information.

7. The communication system according to claim 1, wherein the prompt information is visual prompt information.

8. The communication system according to claim 7, wherein the visual prompt information is displayed as a pop-up window on a display interface of the terminal device.

9. The communication system according to claim 8, wherein
the visual prompt information includes a connect icon; and
an operation on the connect icon renders the terminal device to establish a communication connection with the movable platform.

10. The communication system according to claim 9, wherein
the visual prompt information further includes a cancel icon; and
an operation on the cancel icon renders the terminal device to:
not establish a communication connection with the movable platform, and
not output the prompt information upon receiving a data packet from the movable platform again.

11. The communication system according to claim 1, wherein the prompt information is voice prompt information.

12. The communication system according to claim 11, wherein the terminal device is further configured to
obtain a sound signal after outputting the prompt information; and
establish the communication connection with the movable platform upon determining that the sound signal includes a preset voice signal.

13. The communication system according to claim 1, wherein the prompt information is output in a preset working mode.

14. The communication system according to claim 13, wherein the preset working mode includes at least one of a non-video playing mode, or a non-game mode.

15. The communication system according to claim 1, wherein
the terminal device is further configured to obtain a distance between the movable platform and the terminal device; and
the prompt information is output when the distance is less than a predetermined distance threshold.

16. The communication system according to claim 15, wherein to obtain the distance between the movable platform and the terminal device, the terminal device further:
obtains signal intensity of the data packet; and
determines the distance between the terminal device and the movable platform based on the signal intensity.

17. The communication system according to claim 1, wherein the movable platform is configured to send the data packet through short-range wireless communication.

18. The communication system according to claim 1, wherein the movable platform is at least one of a handheld photographing apparatus, an unmanned aerial vehicle, an unmanned vehicle, or a mobile robot.

19. The communication system according to claim 1, wherein the terminal device is at least one of a mobile phone, a tablet computer, or a remote controller.

20. A communication method, comprising:
receiving, by a terminal device of a communication system, a data packet sent from a movable platform of the communication system, wherein the data packet includes attribute information of the movable platform;
determining, by the terminal device, that the attribute information is preset attribute information; and
outputting, by the terminal device, the data packet, prompt information to indicate whether to establish a communication connection between the terminal device and the movable platform.
